(19) United States
(12) Patent Application Publication
(10) Pub. No.: US 2022/0382819 A1
(43) Pub. Date: Dec. 1, 2022

(54) Search Results Based Triggering For Understanding User Intent On Assistant

(71) Applicant: Google LLC, Mountain View, CA (US)

(72) Inventors: T.V Raman, Mountain View, CA (US); Peng Rong, Mountain View, CA (US); Pravir Gupta, Los Altos, CA (US)

(73) Assignee: Google LLC, Mountain View, CA (US)

(21) Appl. No.: 17/333,074

(22) Filed: May 28, 2021

(51) Int. Cl. G06F 16/9535; G06F 16/9032; G06F 16/9538; G06F 3/16

(52) U.S. Cl. CPC G06F 16/9535; G06F 16/90332; G06F 16/9538; G06F 3/167

(57) ABSTRACT

A method for deliver relevant responses to ambiguous queries includes receiving, from a user device associated with a user, a query requesting either information from a digital assistant service or performance of an action by the digital assistant service. When a user intent of the query is unresolved, the method also includes retrieving, from a search engine, currently trending search results for the query and resolving the user intent of the query based on the search results. The method also includes generating a response to the query based the resolved user intent. The response includes information obtained from a particular intent vertical associated with the resolved user intent or fulfillment of the action by the digital assistant service.

### TECHNICAL FIELD

This disclosure relates to search results based triggering for understanding user intent on assistant.

### BACKGROUND

A user may query a digital assistant executing on a computing device to obtain information and facts about a topic/entity or assist the user in accomplishing a certain task. The digital assistant may require that the user be able to provide sufficient information for guiding the digital assistant toward locating the particular information that is of interest to the user. If a query is not sufficiently tailored, or if the user does not provide much in the way of additional information beyond simply specifying an entity related to the query, the digital assistant may prompt the user a disambiguating question to further narrow the query and attain the user intent. Additionally, the digital assistant may rely on predetermined query interpretations for ambiguous queries that lack user intent by providing default responses which must be updated dynamically.

### SUMMARY

One aspect of the disclosure provides a computer-implemented method for delivering relevant responses to ambiguous queries. The computer-implemented method when executed on data processing hardware causes the data processing hardware to perform operations that include receiving, from a user device associated with a user, a query requesting information from a digital assistant service; and when a user intent of the query is unresolved: retrieving, from a search engine, currently trending search results for the query; resolving the user intent of the query based on the search results; and generating a response to the query based the resolved user intent, the response comprising information obtained from a particular intent vertical associated with the resolved user intent.

Implementations of the disclosure may include one or more of the following optional features. In some implementations, the operations also include, in response to receiving the query: performing query interpretation on the query to determine whether the user intent is ambiguous; and determining the user intent of the query is unresolved when the user intent is ambiguous. In these implementations, performing query interpretation on the query to determine whether the user intent is ambiguous includes processing the query to determine a respective score for each of one or more possible user intents of the query and determining the user intent is ambiguous when the respective score determined for each of the one or more possible user intents of the query fails to satisfy a confidence threshold. Performing query interpretation may also include determining the user intent is unambiguous when the respective score for one of the one or more possible user intents of the query satisfies the confidence threshold.

In some examples, resolving the user intent of the query based on the search results includes identifying the search result in a first position of the currently trending search results for the query retrieved from the search engine, determining at least one of a search result type or entities associated with the search result in the first position, and resolving the user intent based on the at least one of the search result type or the entities associated with the search result in the first position. The entities may include, without limitations, a person, a place, a thing, etc. The resolved user intent may include one of a news-seeking user intent, travel/transportation-related user intent, a music-seeking user intent, and an entertainment-seeking user intent. The particular intent vertical associated with the resolved user intent may include one or more user-preferred information sources.

The user device may include a smart speaker, a smart display, or a mobile computing device. The query may include a spoken query input by the user via an audible user interface executing on the user device or a typed query input by the user via a graphical user interface executing on the user device. The operations may also include providing the response to the query to the user device, the user device configured to output at least one of an audio representation or a graphical representation of the response.

Another aspect of the disclosure provides a system including data processing hardware and memory hardware in communication with the data processing hardware and storing instructions that when executed on the data processing hardware causes the data processing hardware to perform operations. The operations include receiving, from a user device associated with a user, a query requesting information from a digital assistant service; and when a user intent of the query is unresolved: retrieving, from a search engine, currently trending search results for the query; resolving the user intent of the query based on the search results; and generating a response to the query based the resolved user intent, the response comprising information obtained from a particular intent vertical associated with the resolved user intent

This aspect may include one or more of the following optional features. Implementations of the disclosure may include one or more of the following optional features. In some implementations, the operations also include, in response to receiving the query: performing query interpretation on the query to determine whether the user intent is ambiguous; and determining the user intent of the query is unresolved when the user intent is ambiguous. In these implementations, performing query interpretation on the query to determine whether the user intent is ambiguous includes processing the query to determine a respective score for each of one or more possible user intents of the query and determining the user intent is ambiguous when the respective score determined for each of the one or more possible user intents of the query fails to satisfy a confidence threshold. Performing query interpretation may also include determining the user intent is unambiguous when the respective score for one of the one or more possible user intents of the query satisfies the confidence threshold.

In some examples, resolving the user intent of the query based on the search results includes identifying the search result in a first position of the currently trending search results for the query retrieved from the search engine, determining at least one of a search result type or entities associated with the search result in the first position, and resolving the user intent based on the at least one of the search result type or the entities associated with the search result in the first position. The entities may include, without limitations, a person, a place, a thing, etc. The resolved user intent may include one of a news-seeking user intent, travel/transportation-related user intent, a music-seeking user intent, and an entertainment-seeking user intent. The particular intent vertical associated with the resolved user intent may include one or more user-preferred information sources.

The user device may include a smart speaker, a smart display, or a mobile computing device. The query may include a spoken query input by the user via an audible user interface executing on the user device or a typed query input by the user via a graphical user interface executing on the user device. The operations may also include providing the response to the query to the user device, the user device configured to output at least one of an audio representation or a graphical representation of the response.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for resolving user intent of a query when a query directed toward a digital assistant service is ambiguous.

FIG. 2 is a flowchart of an example arrangement of operations for a method of delivering relevant responses to ambiguous queries.

FIG. 3 is a schematic view of an example computing device that may be used to implement the systems and methods described herein.

Like reference symbols in the various drawings indicate like elements.

### DETAILED DESCRIPTION

A user may query a digital assistant interface executing on a computing device to obtain information and facts about a topic/entity or assist the user in accomplishing a certain task. A user may similarly query the digital assistant interface requesting a digital assistant to perform an action/operation. The digital assistant may require that the user be able to provide sufficient information for guiding the digital assistant toward locating the particular information (or identifying the particular action) that is of interest to the user. If a query is not sufficiently tailored, or if the user does not provide much in the way of additional information beyond simply specifying an entity related to the query, the digital assistant may prompt the user to answer a disambiguating question to further narrow the query and attain the user intent. A user may be bothered by the additional time incurred in having to answer the disambiguating question before receiving a response.

Additionally, the digital assistant may rely on predetermined query interpretations for ambiguous queries that lack user intent by providing default responses which must be updated dynamically. It is a tedious process for an administrator of the digital assistant service to update predetermined interpretations for ambiguous queries in a timely fashion, making it difficult to constantly maintain accurate interpretations for a potentially endless number of possible ambiguous queries. Implementations herein are directed toward disambiguating ambiguous queries by referencing currently trending search results related to the query 120 in order to resolve/extract a contextually-relevant user intent. As will become apparent, the search results may allow a digital assistant service to ascertain a relevant user intent for an ambiguous query dynamically and without requiring the user to provide additional information (e.g., answer a disambiguating question or retailor the query).

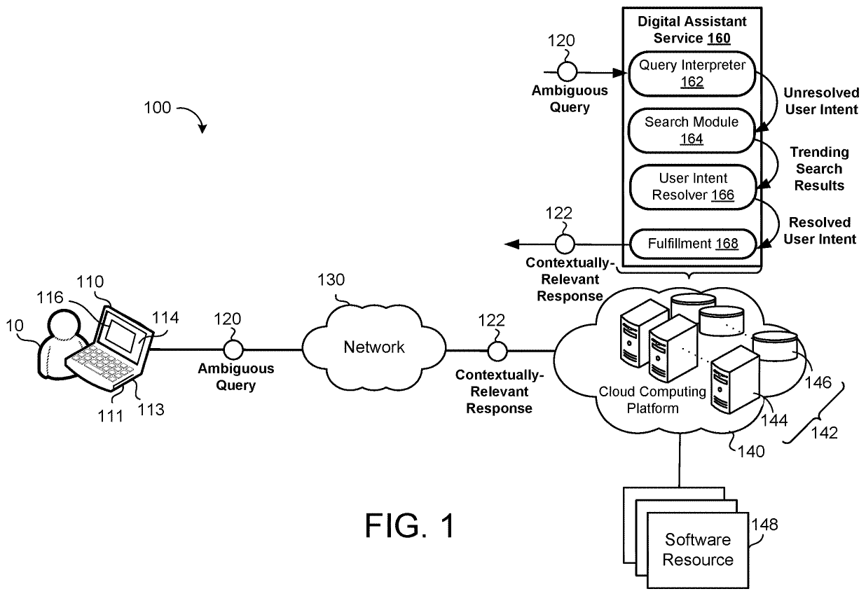

FIG. 1 is an example system 100 that includes a user device 110 associated with a user 10 that is capable of communicating queries 120 (e.g., also referred to as client content/data) over a network 130 to a distributed system (e.g., cloud computing platform) 140. The distributed system 140 may have scalable/elastic resources 142 (e.g., a storage abstraction) remote from local resources of the user device 110. The resources 142 include hardware resources 144 (e.g., data processing hardware), storage resources 146 (e.g., memory hardware), and/or software resources 148 (e.g., web-based applications or application programming interfaces (APIs)). In some examples, the distributed system 140 executes a digital assistant service (DAS) 160 and the user 10 interfaces with the DAS 160 using the user device 110 (e.g., using a digital assistant interface 114 or a web-browser application 116).

The user device 110 can be any computing device or data processing hardware capable of communicating with the distributed system 140. Some examples of user devices 110 include, but are not limited to, desktop computing devices, mobile computing devices, such as laptops, tablets, smart phones, smart televisions, set-top boxes, smart speakers/displays, smart appliances, vehicle infotainment, and wearable computing devices (e.g., headsets and/or watches). As a computing device, the user device 110 includes data processing hardware 111 and memory hardware 113 configured to communicate with the data processing hardware 111 to execute various processes. Here, FIG. 1 depicts the user device 110 using the data processing hardware 111 to execute applications 114, 116 (e.g., applications that have been downloaded and stored in the memory hardware 113). For instance, the user device 110 executes an interface 114 or a web-browser application 116 to communicate with web-based services offered by the DAS 160 and accessible to the user device 110 via the interface 114 or web-browser application 116.

The user 10 may issue queries 120 to the DAS 160 to obtain information and facts about a topic/entity and/or request to the DAS 160 to perform an action/operation. For instance, a query 120 requesting information could include “Who is Michael Jackson”, whereas a query requesting performance of an action/operation could include “Play Michael Jackson”. The interface 114 may include a graphical user interface associated with the DAS 160. In some examples, the interface 114 includes an audible user interface or a combination of a graphical/audible user interface for allowing the user 10 to issue a query 120 to the DAS 160 and output a response 122 to the query 120 returned from the DAS 160. Accordingly, the user 10 may input spoken or typed queries 120 via the interface 114 and the user device 110 may transmit the query 120 to the DAS 160 to process the query 120 and return a response 122. With a user interface 114 having both graphical and audible capabilities, the response 122 returned by the DAS may be a multimodal response 122 that may incorporate multiple synchronized output modalities. In a non-limiting example, a multimodal response incorporating multiple synchronized output modalities could include a multimedia component such as a video including both audio and visual tracks, as well as other components such as synthesized speech from the DAS 160 that conveys general information about the returned response 122. When the query 120 is spoken, the user device 110 may perform speech recognition on audio data corresponding to the query to obtain a transcription and transmit the transcription of the query 120 over the network 130 to the DAS 160. Optionally, the user device 110 may transmit the audio data corresponding to the spoken query 120 to a server-side speech recognizer that executes on the distributed system 140 to obtain the transcription of the query 120.

In the example shown, the DAS 160 includes a query interpreter 162 configured to process the query 120 by performing query interpretation on the query 120. The query interpreter 162 may determine whether or not a user intent can be resolved such that the query 120 is unambiguous. As used herein, an unambiguous query refers to a query in which the user intent is explicitly specified by in the query, or can be reasonably inferred with sufficient confidence. A user intent may be one of multiple predefined intents that may correspond to information seeking intents as well as intents related to action requests. For instance, the predefined intents may include news-seeking intents, transportation/travel-related intents, music-seeking intents, entertainment-related intents, home/office/automobile automation-command intents, etc. The query interpreter 162 may generate a score associated with an intent. The score of an intent may indicate a degree of confidence (e.g., a probability or other degree of likelihood) that the query 120 is to obtain information that satisfies the intent. Accordingly, the query interpreter 162 may output a probability distribution over possible intents for the query 120. When a score for an intent satisfies a confidence threshold, the query interpreter 162 may determine that the user intent of the query 160 is resolved so that the DAS 160 can access an appropriate intent vertical to obtain the information responsive to the query 120.

Otherwise, when the user intent is unresolved, e.g., when none of the scores generated for the possible intents satisfy the confidence threshold, the DAS 160 deems the query 120 as ambiguous. In scenarios when the DAS 120 determines a user intent of the query 120 is unresolved/ambiguous, the DAS 160 may simply provide a default response. For instance, if the query 120 only includes the entity-specifying terms “Tiger Woods”, the query interpreter 162 would be unable to determine whether the user intent is to view popular videos (e.g., You Tube) of Tiger Woods playing golf, whether the user intent is news seeking to attain currently trending news about the golfer Tiger Woods, or some other user intent because the user intent was not explicit in the query 120. In this example, the default response provided by the DAS 120 may include some general bibliographic information about the golfer Tiger Woods. However, if the query 120 were provided shortly after Tiger Wood's car accident in California, there is a strong likelihood that the user wants to ascertain news about the car accident, in which the default response conveying bibliographic information about Tiger Woods has little value to the user.

Implementations herein are directed toward leveraging currently trending search results related to the query 120 in order to resolve/extract a user intent when the query interpreter 162 determines the query 120 is ambiguous. Accordingly, the DAS 160 may use the resolved user intent to generate a contextually-relevant response 122 to the query 120, whereby the response 122 includes information attained from a particular intent vertical associated with the resolved user intent. In the example shown, the DAS 160 may invoke a search module (e.g., search engine) 164 to conduct a search related to an ambiguous query 120 in response to the query interpreter 162 determining that a user intent of the query is unresolved. Here, the query 120 may include one or more terms that specify an entity/topic for use as the search terms by the search engine 164 for conducting the search. After conducting the search, the search module 164 may output a list of currently trending search results for the query 120 to a user intent resolver 166. Here, the user intent resolver 166 may identify the search result in in the first position of the currently trending search results retrieved from the search module 164, determine a search result type associated with the search result in the first position, and then resolve/extract the user intent based on the search result type associated with the search result in the first position. The “search result type” may refer to a response vertical such as bibliographic, news, music, transportation/travel. For instance, applying the example above, a search result in the first position of currently trending search results related to the query “Tiger Woods” would be associated with a search result type of news-seeking shortly after the car accident. As such, the intent resolver 166 would resolve the user intent as being news-seeking to prompt fulfillment 168 of the query and generate a news-seeking response rather than the default response containing bibliographic information for Tiger Woods. Accordingly, the fulfillment 168 at the DAS 160 generates and delivers a more relevant response 122 to the query 120 in the context of the real world by leveraging currently trending search results.

Notably, if the search module 164 performed the same search related to the ambiguous query 120 some time prior to the car accident Tiger Woods was in, the search result in the first position would likely be associated with the bibliographic-related search result type. In this scenario, the intent resolver 166 would resolve the user intent as being bibliographic-related, and thereby cause the fulfillment 168 of the query 120 by generating the same response as the default response containing the bibliographic information for Tiger Woods. Accordingly, the DAS 160 may deliver contextually-relevant responses 122 to ambiguous queries 120 that change dynamically based on currently trending search results.

Interestingly, when the user intent is resolved based on the currently trending search results, the DAS 160 does not simply revert to providing the search result in the first position of the currently trending search results. Rather, the DAS 160 resolves the user intent from the search result type associated with this search result and then cross-references the resolved user intent with the default interpretation of the ambiguous query to determine a most relevant response 122 to the query 120 in in the context of the real-world. Here, the most relevant response 122 will include information obtained from a particular intent vertical associated with the resolved user intent that is curated for the particular user. That is, the particular intent vertical may include one or more information sources related to the search result type associated with the search result in the first position, however, these information sources may be preferred by the user over other information sources that are also related to the search result type. These user-preferred information sources associated with the different intent verticals may be previously specified by the user and/or learned based on past interactions between the user 10 and the DAS 160. Moreover, the user-preferred information sources for the intent verticals may be stored in a user profile associated with the user and accessible to the DAS 160. For instance, in the example above, news-seeking user intents for the particular user may include the fulfillment accessing information only from specific news sources specified by the user preferences, wherein these news sources may be different than the news source that provided the search result in the first position of the currently trending search results. Here, the user 10 may prefer to receive news from his/her local newspaper whereas the news source that provided the search result in the first position may include a national news conglomerate.

In another example where the resolved user intent is music-seeking, the particular intent vertical associated with the music-seeking user intent may include a preferred music streaming service that the user uses for listening to music. In this example, the search result type that was music-seeking may include a search result in the first position that includes a link for audible playback of music streamed from a different music streaming service that the search engine 164 defaults to.

Additionally or alternatively, the DAS 160 may determine whether similar queries were recently received from other user devices associated with other users. As used herein, similar queries may include similar terms that specify a same entity as the unresolved query. These similar queries may explicitly convey user intent, or the user intent may already be resolved. Here, the query resolver 166 may determine whether there is a recent spike in similar queries and identify a common user intent shared by a threshold number of the similar queries. Accordingly, the query resolver 166 may resolve the user intent by extracting the common user intent shared by the threshold number of queries in the recent spike of similar queries received at the DAS 160 from other users.

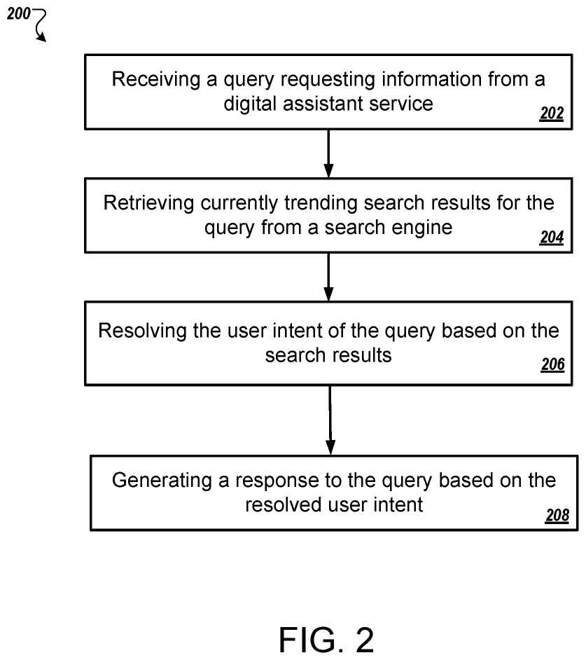

FIG. 2 is a flowchart of an example arrangement of operations for a method 200 of delivering relevant responses to ambiguous queries. At operation 202, the method 200 includes receiving, from a user device 110 associated with a user 10, a query 120 requesting information from a digital assistant service (DAS) 160. Operations 204-208 are performed when a user intent of the query 120 is unresolved. At operation 204, the method 200 includes retrieving, from a search engine 164, currently trending search results for the query 120. At operation 206, the method 200 includes resolving the user intent of the query based on the search results. At operation 208, the method 200 includes generating a response 122 to the query 120 based on the resolved user intent. Here, the response 122 includes information obtained from a particular intent vertical associated with the resolved user intent.

The DAS 160 may include a query interpreter 162 that performs query interpretation on the received query to determine whether the user intent is ambiguous and determine the user intent of the query 120 is unresolved when the user intent is ambiguous. In some examples, the query interpreter 162 processes the query 120 to determine a respective score for each of one or more possible user intents of the query and determines the user intent is ambiguous when the respective score determined for each of the one or more possible user intents of the query fails to satisfy a confidence threshold.

In some implementations, resolving the user intent of the query based on the search results includes identifying the search result in a first position of the currently trending search results for the query retrieved from the search engine, determining a search result type associated with the search result in the first position, and resolving the user intent based on the search result type associated with the search result in the first position. The resolved user intent may include one of a news-seeking user intent, travel/transportation-related user intent, a music-seeking user intent, and an entertainment-seeking user intent. The particular intent vertical associated with the resolved user intent may include one or more user-preferred information sources.

The user device may include a smart speaker or a smart display. Additionally, the user device may include a mobile computing device such as, without limitation, a smart phone, tablet, or laptop. The query may include a typed query input by the user via graphical user interface 14 executing on the user device or the query may include a spoken query input by the user via an audible user interface executing on the user device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

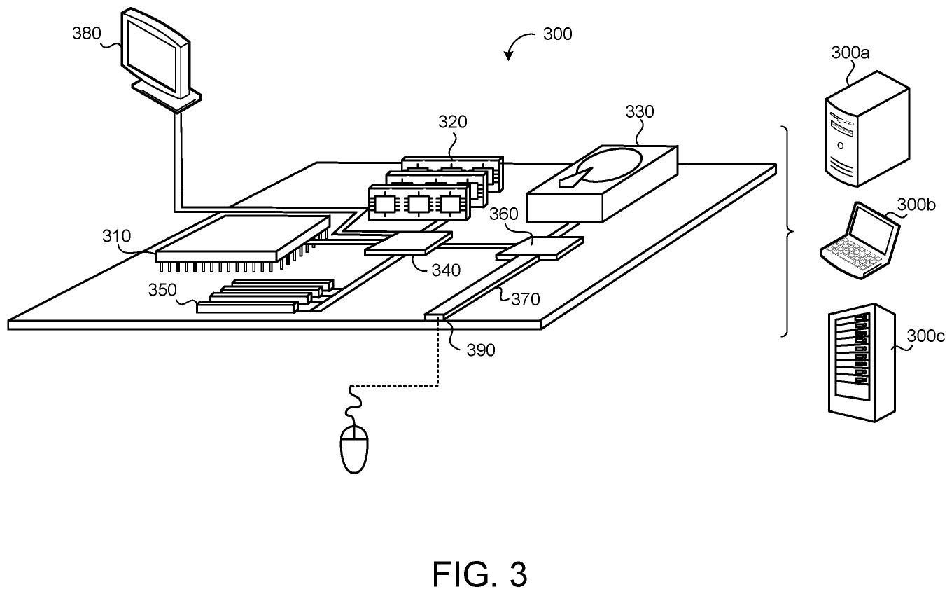

FIG. 3 is schematic view of an example computing device 300 that may be used to implement the systems and methods described in this document. The computing device 300 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 300 includes a processor 310, memory 320, a storage device 330, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 can process instructions for execution within the computing device 300, including instructions stored in the memory 320 or on the storage device 330 to display graphical information for a graphical user interface (GUI) on an external input/output device, such as display 380 coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 stores information non-transitorily within the computing device 300. The memory 320 may be a computer-readable medium, a volatile memory unit(s), or non-volatile memory unit(s). The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 300a or multiple times in a group of such servers 300a, as a laptop computer 300b, or as part of a rack server system 300c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method that, when executed on data processing hardware, causes the data processing hardware to perform operations for delivering relevant query responses, the operations comprising:
receiving, from a user device associated with a user, a query requesting either information from a digital assistant service or performance of an action; and
when a user intent of the query is unresolved:
retrieving, from a search engine, currently trending first search results for the query;
resolving the user intent of the query based on a search result type associated with a relevant search result of the first search results;
identifying, based on the resolved user intent, a particular intent vertical for the user, the particular intent vertical comprising one or more user-preferred information sources associated with the search result type and identified in a user profile associated with the user;
retrieving, from a search engine, second search results for the query based on the one or more user-preferred information sources of the particular intent vertical; and
generating a response to the query, the response comprising:
information obtained from the second search results; or
fulfillment of the action performed by the digital assistant service, the action identified based on the second search results.

2. The method of claim 1, wherein the operations further comprise, in response to receiving the query:
performing query interpretation on the query to determine whether the user intent is ambiguous; and
determining the user intent of the query is unresolved when the user intent is ambiguous.

3. The method of claim 2, wherein performing query interpretation on the query to determine whether the user intent is ambiguous comprises:
processing the query to determine a respective score for each of one or more possible user intents of the query; and
determining the user intent is ambiguous when the respective score determined for each of the one or more possible user intents of the query fails to satisfy a confidence threshold.

4. The method of claim 3, wherein performing query interpretation further comprises determining the user intent is unambiguous when the respective score for at least one of the one or more possible user intents of the query satisfies the confidence threshold.

5. The method of claim 1, wherein the relevant search result comprises the search result in a first position of the first search results for the query retrieved from the search engine.

6. The method of claim 1, wherein the resolved user intent comprises one or more of a news-seeking user intent, travel/transportation-related user intent, a music-seeking user intent, an automation-command intent, or an entertainment-seeking user intent.

7. (canceled)

8. The method of claim 1, wherein the user device comprises a smart speaker.

9. The method of claim 1, wherein the user device comprises a smart display.

10. The method of claim 1, wherein the user device comprises a mobile computing device.

11. The method of claim 1, wherein the query comprises a spoken query input by the user via an audible user interface executing on the user device.

12. The method of claim 1, wherein the query comprises a typed query input by the user via a graphical user interface executing on the user device.

13. The method of claim 1, wherein the operations further comprise providing the response to the query to the user device, the user device configured to output at least one of an audio representation or a graphical representation of the response.

14. A computer-implemented method that, when executed on data processing hardware, causes the data processing hardware to perform operations for delivering relevant query responses, the operations comprising:
receiving, from a user device associated with a user, a query requesting either information from a digital assistant service or performance of an action by the digital assistant service; and
when a user intent of the query is unresolved:
determining whether there is a recent spike of similar queries from other users;
when there is a recent spike in similar queries, resolving the user intent of the query based on a search result type associated with the recent spike in similar queries;
identifying, based on the resolved user intent, a particular intent vertical for the user, the particular intent vertical comprising one or more user-preferred information sources associated with the search result type and identified in a user profile associated with the user;
retrieving, from a search engine, search results for the query based on the one or more user-preferred information sources of the particular intent vertical; and
generating a response to the query, the response comprising:
information obtained from the search results; or
fulfillment of the action performed by the digital assistant service, the action identified based on the search results.

15. The method of claim 14, wherein resolving the user intent of the query based on the recent spike of similar queries comprises resolving the user intent by extracting a common user intent shared by a threshold number of recent queries in the recent spike of similar queries from the other users.

16. A system comprising:
data processing hardware; and
memory hardware in communication with the data processing hardware, the memory hardware storing instructions that, when executed on the data processing hardware, cause the data processing hardware to perform operations comprising:
receiving, from a user device associated with a user, a query requesting either information from a digital assistant service or performance of an action by the digital assistant service; and
when a user intent of the query is unresolved:
retrieving, from a search engine, currently trending first search results for the query;
resolving the user intent of the query based on a search result type associated with a relevant search result of the first search results;
identifying, based on the resolved user intent, a particular intent vertical for the user, the particular intent vertical comprising one or more user-preferred information sources associated with the search result type and identified in a user profile associated with the user;
retrieving, from a search engine, second search results for the query based on the one or more user-preferred information sources of the particular intent vertical; and
generating a response to the query, the response comprising:
information obtained from the second search results; or
fulfillment of the action performed by the digital assistant service, the action identified based on the second search results.

17. The system of claim 16, wherein the operations further comprise, in response to receiving the query:
performing query interpretation on the query to determine whether the user intent is ambiguous; and
determining the user intent of the query is unresolved when the user intent is ambiguous.

18. The system of claim 17, wherein performing query interpretation on the query to determine whether the user intent is ambiguous comprises:
processing the query to determine a respective score for each of one or more possible user intents of the query; and
determining the user intent is ambiguous when the respective score determined for each of the one or more possible user intents of the query fails to satisfy a confidence threshold.

19. The system of claim 18, wherein performing query interpretation further comprises determining the user intent is unambiguous when the respective score for at least one of the one or more possible user intents of the query satisfies the confidence threshold.

20. The system of claim 16, wherein the relevant search result is the search result in a first position of the first search results for the query retrieved from the search engine.

21. The system of claim 16, wherein the resolved user intent comprises one or more of a news-seeking user intent, travel/transportation-related user intent, a music-seeking user intent, an automation-command intent, or an entertainment-seeking user intent.

22. (canceled)

23. The system of claim 16, wherein the user device comprises a smart speaker.

24. The system of claim 16, wherein the user device comprises a smart display.

25. The system of claim 16, wherein the user device comprises a mobile computing device.

26. The system of claim 16, wherein the query comprises a spoken query input by the user via an audible user interface executing on the user device.

27. The system of claim 16, wherein the query comprises a typed query input by the user via a graphical user interface executing on the user device.

28. The system of claim 16, wherein the operations further comprise providing the response to the query to the user device, the user device configured to output at least one of an audio representation or a graphical representation of the response.
